(19) United States
(12) Patent Application Publication
(10) Pub. No.: US 2026/0301633 A1
(43) Pub. Date: Oct. 1, 2026

(54) ACCESS POINT DEVICE THAT INTERFACES BETWEEN ELECTRONIC LABEL DEVICE AND MANAGEMENT SERVER

(71) Applicant: 4SEILS Co., Ltd., Seoul (KR)

(72) Inventors: Song On LEE, Seoul (KR); Young Jun KIM, Hwaseong-si (KR); Sang Min LEE, Seongnam-si (KR); Yong Tae KIM, Gimpo-si (KR)

(73) Assignee: 4SEILS Co., Ltd., Seoul (KR)

(21) Appl. No.: 19/199,279

(22) Filed: May 5, 2025

(30) Foreign Application Priority Data
Apr. 1, 2025 (KR) 10-2025-0041949

(51) Int. Cl. G09G 3/20

(52) U.S. Cl. CPC G09G 3/2003; G09G 2320/0666; G09G 2370/16; G09G 2380/04

(57) ABSTRACT

According to one aspect of the proposed invention, an access point device, which interfaces between a plurality of electronic label devices and a management server, includes a processor configured to execute program instructions, in which the program instructions, when executed by the processor, perform a reception control operation of color display control data, a reception operation of the color display control data, a processing operation of the color display control data, a generation operation of color image data, and a transmission control operation of the color image data, and thus the design utilization range of the electronic label device is maximized and visual quality is improved.

### CROSS-REFERENCE TO RELATED APPLICATION

This application claims priority from Korean Patent Application No. 10-2025-0041949, filed on Apr. 1, 2025, in the Korean Intellectual Property Office, the disclosure of which is incorporated herein by reference in its entirety.

### BACKGROUND

### 1. Field

The following description relates to an access point device that interfaces between an electronic label device, specifically, an electronic label device that electronically displays information on products displayed in a store, and a management server.

### 2. Description of Related Art

An electronic information label (EIL) or electronic shelf label (ESL) is an electronic device that electronically displays information on products in place of paper labels on product display shelves in a store. An electronic information label (device) has the advantage of extremely low power consumption and ensuring clear readability even under ambient lighting. In addition, an electronic information label based on E-Ink requires almost no separate power to maintain an image once displayed, and thus long-term still screen display is possible.

Since it is important for the electronic information label to be mass-produced at a low price while having the characteristics of low power consumption, an electronic information label with limited functions such as expressing only three colors of black, white, and red, four colors of black, white, red, and yellow, or six colors of black, white, red, yellow, blue, and green are being used, and due to this limited color expression, there are inevitably limitations in appealing to customers to purchase products.

A Korean patent publication (Korean Laid-open Patent Publication No. 10-2016-0121121, “Color data transmission method of electronic price display, electronic price display server, and electronic price display system”) discloses a technology for generating color data to be transmitted by a management server to a relay, but has a problem in that the burden on the management server increases.

In addition, a Korean patent publication (Korean Laid-open Patent Publication No. 10-2009-0054753, “Color flexible electronic paper display”) discloses a technology for providing a color electronic paper display that does not require a separate electrode by having an electrically conductive color layer serve as an electrode, but has limitations in expressing colors with various tones, brightness, or saturation.

Accordingly, the development of a system that allows an electronic information label to express various colors and reduces the burden on the management server is required.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to enabling more diverse colors to be expressed in an electronic label device having a limited dot color palette.

Furthermore, the following description relates to providing a method of expressing colors with various tones, brightness, or saturation even when the electronic label device supports only a limited number of pixel colors.

Furthermore, the following description relates to providing a method of processing palette color pattern data in an access point device so that the electronic label device can express rich colors while reducing the burden on the management server.

In one general aspect, an access point device that interfaces between a plurality of electronic label devices and a management server includes a processor configured to execute program instructions, and the program instructions, when executed by the processor, perform a reception control operation of color display control data, a reception operation of the color display control data, a processing operation of the color display control data, a generation operation of color image data, and a transmission control operation of the color image data.

In the general aspect, the processing operation of the color display control data includes a determination operation of the number of colors to determine whether the number of colors that the display displays is less than the number of colors according to the received color display control data, and a dithering processing operation for performing dithering processing on the color display control data when the number of colors that the display displays is less than the number of colors according to the received color display control data.

Other features and aspects will be apparent from the following detailed description, the accompanying drawings, and the claims.

### BRIEF DESCRIPTION OF THE DRAWINGS

FIG. 1 illustrates an electronic label system including an access point device according to one embodiment.

FIG. 2 is a block diagram illustrating a configuration of the access point device according to one embodiment.

FIG. 3 is a flowchart describing an operation for executing program instructions by a processor according to one embodiment.

FIG. 4 is a flowchart describing a processing operation of color display control data according to one embodiment.

FIG. 5 illustrates palette color pattern information representing dithered color image data according to one embodiment.

FIG. 6 illustrates an electronic label device that displays various colors according to a display template according to one embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It is understood that components of each embodiment can be combined in various ways within an embodiment or with components of other embodiments, unless there is any other mention or contradiction between the components. Based on the principle that the inventor may appropriately define the concepts of terms in order to best explain his or her own invention, the terms used in this specification and claims should be interpreted with meanings and concepts that are consistent with the described content or proposed technical idea.

In this specification, blocks expressed as “circuits” or “units” with reference to block diagrams may be configured as hardware such as dedicated semiconductors, gate arrays, FPGAs, or parts thereof. A single block or a plurality of blocks may be implemented as a single piece of hardware. As another example, these blocks may be implemented in software as an information processing device in which the computational elements execute program instructions stored in the memory elements. A plurality of blocks may be implemented as a part of a program that is executed on the same computational element. As another example, these blocks may be implemented in a hybrid form, with some individual circuits thereof being hardware and some being software. In a software implementation, the computational elements may include digital signal processors, dedicated computational processors, artificial intelligence processing engines, dedicated artificial intelligence processors, graphics processors, or any combination of these to the extent possible.

Hereinafter, exemplary embodiments of the present invention will be described in detail with reference to the accompanying drawings.

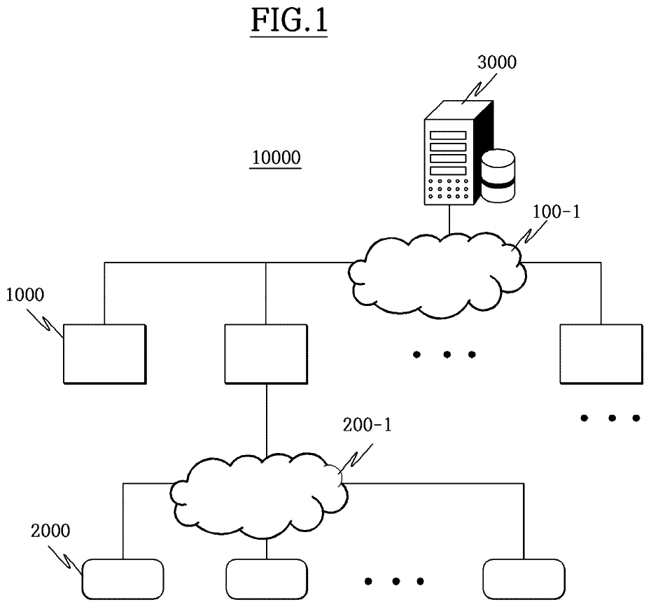

FIG. 1 illustrates an electronic label system 10000 including an access point device according to one embodiment. The electronic label system according to one embodiment may include a management server 3000, a plurality of access point devices 1000, and multiple electronic label devices 2000.

The management server 3000 manages data to be displayed on an electronic label. The management server 3000 is connected to a sales management server through a network, for example, and receives information on products displayed in a store. In addition, the management server 3000 may manage information on electronic label devices installed in a store, for example, assignment information regarding which electronic label device is assigned to which product, or configuration information of each electronic label device, for example, specification information of a display or communication identification information.

The management server 3000 may transmit data to the multiple electronic label devices 2000 that are divided into multiple groups and managed by the access point device 1000. The management server 3000 may be connected to the access point device 1000 through a first network 100-1, such as a cloud network or the Internet. The access point device 1000 and the electronic label device 2000 may be connected to each other through a second network 200-1, and this second network 200-1 may use short-range wireless communication, for example, the Zigbee protocol or the Bluetooth Low Energy (BLE) method defined in the Bluetooth standard.

The access point device to which the proposed invention may be applied is interposed between the management server and the electronic label device, and distributes or transfers data transmitted from the management server to the electronic label device. It may take several minutes or even tens of minutes for the access point device to transmit individual data to a large number of electronic label devices.

In general, the management server generates a display image according to the configuration information of the electronic label device and transfers the display image to the access point, and the access point only transfers the display image. However, this increases the processing burden of the server and requires a large capacity memory in the access point. As another method, it is conceivable that the server generates and transmits only metadata and each electronic label device generates display data with a template. However, this requires a high-performance processor in the electronic label device, and this cost increase will lead to an increase in the unit price of electronic labels installed in tens of thousands of units at each store, which will have fatal consequences for business viability in this field, and thus the cost increase is something that should be absolutely avoided.

The electronic label device 2000 may be, for example, an electrophoretic display having a bi-stable property in which microcapsules are sealed between a transparent electrode and a driving electrode, the microcapsules are specifically arranged and a display state thereof changes in response to the voltage applied to the two electrodes, and the display state is maintained even when the driving voltage is removed, but is not limited thereto and various technologies may be applied thereto.

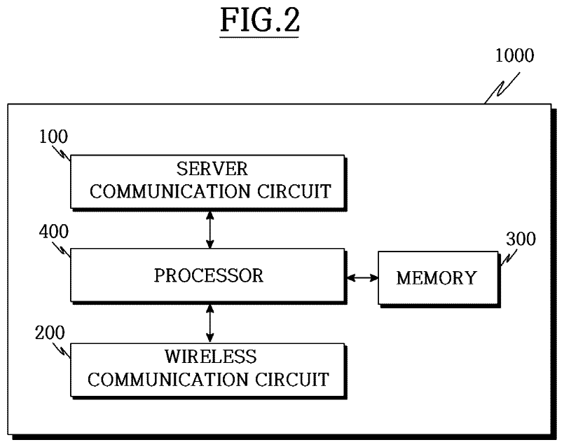

FIG. 2 is a block diagram illustrating a configuration of an access point device according to one embodiment. As illustrated, the access point device 1000 according to one embodiment includes a server communication circuit 100, a wireless communication circuit 200, a memory 300, and a processor 400.

The server communication circuit 100 may be connected to the management server 3000 through a first network 100-1 and receive color display control data. The server communication circuit 100 may be implemented as a circuit that supports communication protocols such as Ethernet, Wireless-Fidelity (Wi-Fi), Long Term Evolution (LTE), and fifth generation (5G). The first network 100-1 may be a wireless communication network or a wired communication network.

The wireless communication circuit 200 may be connected to the electronic label device 2000 through a second network 200-1 and transmit display data wirelessly. The wireless communication circuit 200 may be implemented as a circuit that supports a low-power wireless communication protocol such as Zigbee, BLE, etc.

The memory 300 stores a display template including program instructions (executable instructions) and configuration information of the display. The memory 300 may be configured as a non-volatile memory (e.g., flash memory) or a volatile memory (e.g., DRAM). The configuration information of the display may include a resolution and the number of colors.

The processor 400 is configured to execute program instructions stored in the memory 300 and controls a color display operation of the electronic label device 2000. The processor 400 may be implemented as a microprocessor, a microcontroller, or a digital signal processor (DSP). The electronic label device 2000 may include a driver IC circuit.

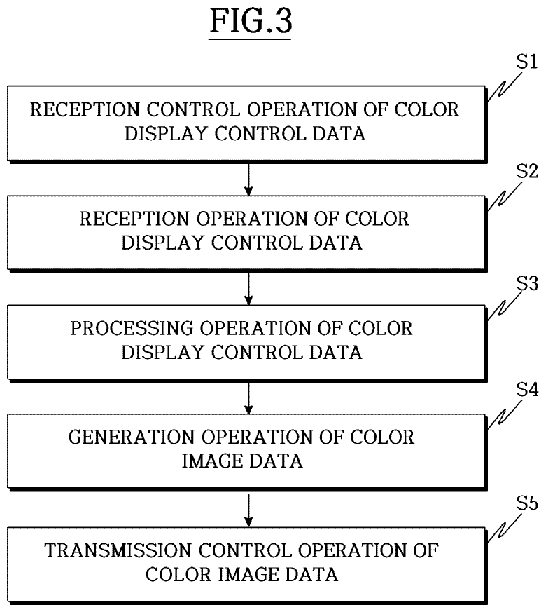

FIG. 3 is a flowchart illustrating an operation for executing program instructions by a processor according to one embodiment. The program instructions executed by the processor 400 include instructions configured to, when executed by the processor, perform a reception control operation of color display control data (S1), a reception operation of the color display control data (S2), a processing operation of the color display control data (S3), a generation operation of color image data (S4), and a transmission control operation of the color image data (S5).

The program instruction(s) may be executable instructions.

In the reception control operation of color display control data (S1), the server communication circuit 100 is controlled to receive color display control data from the management server 3000.

In the reception operation of the color display control data (S2), the color display control data is received from the server communication circuit 100. The color display control data received by the processor 400 may be data generated by the management server 3000.

In the processing operation of the color display control data (S3), the color display control data is processed.

In the generation operation of the color image data (S4), color image data to be displayed on the display is generated from the color display control data according to a display template (metadata) stored in the memory 300, but is generated differently according to the configuration information of the display. The display template includes the configuration information of the display, and this configuration information may be at least one of display content information, arrangement information, size information, and text font information.

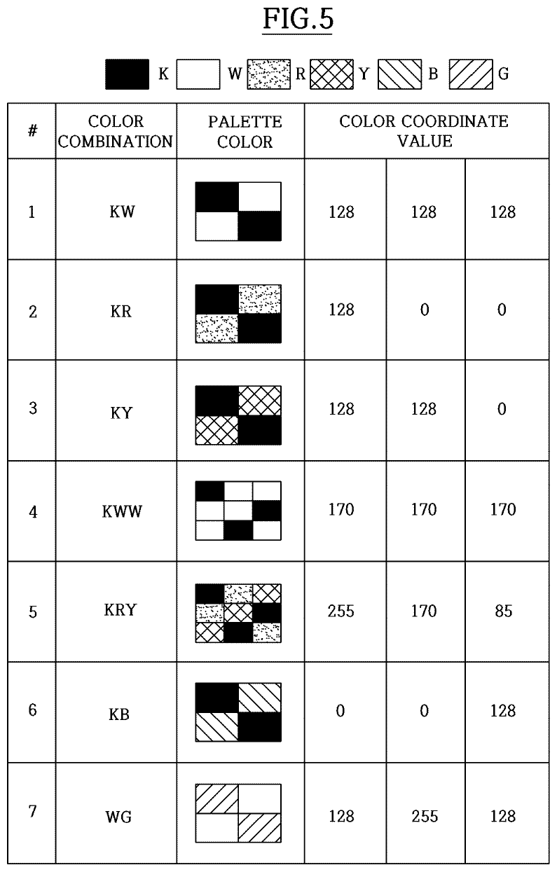

According to one embodiment, the color image data may include color information in which at least two of black (B), white (W), and red (R) are combined. According to another embodiment, the color image data may include color information in which at least two of black (B), white (W), yellow (Y), and red (R) are combined. A detailed description of the color combination will be made in detail below with reference to FIG. 5.

In the transmission control operation of the color image data (S5), the wireless communication circuit 200 is controlled to receive color image data and wirelessly transmit the color image data to the electronic label device 2000.

According to one embodiment, the processor 400 may transmit the color image data to the wireless communication circuit 200 in a compressed state using the DEFLATE algorithm according to the RFC 1951 standard.

Lossless compression technology, for example, the RFC 1951 standard commonly referred to as the Deflate format, is known. This compression algorithm is implemented as a sufficiently lightweight software library and is used in smart devices, computers, servers, etc. However, in the electronic label device 2000 where low-cost, low-power driving is an important consideration, when a decompression circuit is implemented with such software, an expensive microprocessor and a large capacity of memory are required, which leads to an increase in cost.

Therefore, the present invention proposes a new structure that implements a lossless decompression algorithm at a low cost. According to one embodiment, this is achieved by concurrently processing decoding by a decoding circuit implemented with an internal dedicated logic while an independent controller writes decoded data to an external flash memory.

With this configuration, since decoding processing of the decoding circuit and a process of writing the decoded data to the external flash memory by the independent controller are controlled, decoding may proceed concurrently during the time required for writing to the flash memory. Furthermore, since decoding of a decoding tree is processed in software, it becomes possible to widely support standards such as DEFLATE having various options.

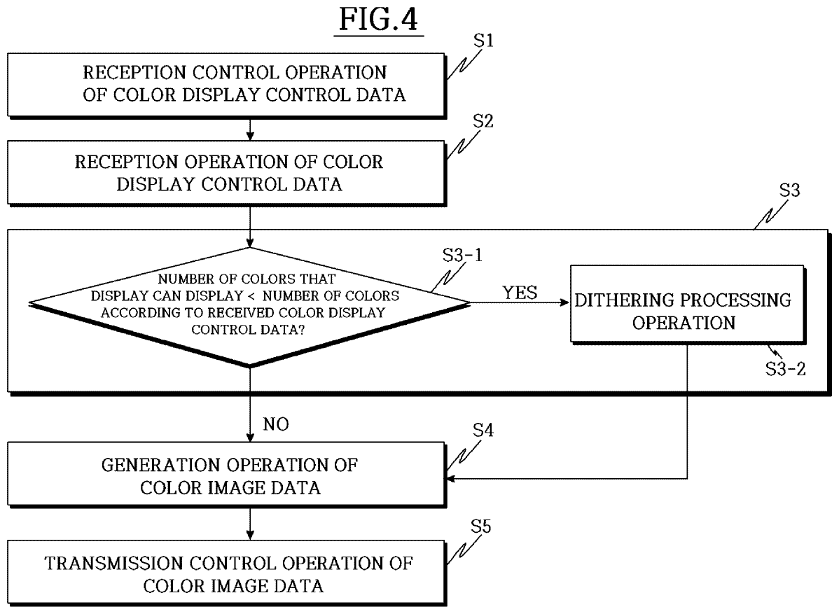

FIG. 4 is a flowchart illustrating a processing operation of color display control data according to one embodiment. As illustrated, the processing operation of the color display control data (S3) may include a number determination operation (S3-1) for determining whether the number of colors that the display can display is less than the number of colors according to the received color display control data, and a dithering processing operation (S3-2) for performing dithering processing on the color display control data when the number of colors that the display can display is less than the number of colors according to the received color display control data.

As a result, the number of displayable colors may increase. According to one embodiment, in the dithering processing operation (S3-2), the Euclidean distance is calculated to generate a color closest to the color display control data provided by the management server 3000, and color image data corresponding to the color may be generated.

When the number of colors that the display can display is greater than the number of colors according to the received color display control data, the dithering processing operation (S3-2) may not be performed. In this case, the color (pixel color) that the display can display may be generated as color image data.

According to one embodiment, the color display control data may be configured in the form of metadata that includes content to be displayed on the electronic label device 2000 and color information. The color display control data may be metadata that includes at least one of the resolution and the number of colors.

According to one embodiment, the display template of the electronic label device 2000 may be configured in the form of metadata. The display template may be metadata that includes at least one of a product image, a product name, a price, a discount rate, and a country of origin.

As a result, the access point device 1000 may reduce the burden on data processing of the management server and reduce network traffic by receiving only metadata from the management server 3000 and generating color image data on its own.

FIG. 5 illustrates palette color pattern information representing dithered color image data according to one embodiment. As illustrated, the palette color pattern information may include information about a plurality of palette colors in each of which a plurality of pixel colors are combined. “Palette color” may refer to a color in which a plurality of pixel colors are combined. The combined colors may be seen as one color to the human eye. The electronic label device 2000 can generally express only limited pixel colors such as three colors of black, white, and red, four colors of black, white, red, and yellow, or six colors of black, white, red, yellow, blue, and green. The present invention provides palette color pattern data that expresses more diverse colors by combining these limited pixel colors into various patterns and utilizing tone techniques. In the present invention, “pixel color” means a basic color (black, white, red, yellow, blue, or green) that the electronic label device can directly display, and “palette color” means an extended color that is visually recognized through a specific pattern combination of these pixel colors.

Therefore, according to one embodiment, when the number of colors (the number of pixel colors) that the display can display is less than the number of colors according to the received color display control data, a dithering algorithm can be used to perform dithering processing to generate a palette color.

In one embodiment, the palette color pattern data for a three-color electronic label device may include 10 patterns, palette color pattern data for a four-color electronic label device may include 22 patterns, and palette color pattern data for a six-color electronic label device may include 50 patterns. Each pattern is designed to be recognized as a specific color by human vision by combining a plurality of pixel colors in a specific arrangement.

For example, a KW pattern is a pattern in which black (K) and white (W) pixels are arranged in a chessboard pattern so that an RGB value is perceived as gray with (128, 128, 128). Similarly, a KR pattern is a combination of black (K) and red (R) pixels to express dark red with an RGB value of (128, 0, 0).

These palette color patterns are designed to express colors with various tones, brightness, and saturation by adjusting the arrangement of pixel colors, dot density (pixel density), and the order of adjacent color blocks. For example, when yellow and red pixels are arranged in a specific pattern, an orange-toned color can be expressed. The palette color may differ from the pixel color in at least one of brightness, saturation, and hue.

According to one embodiment, the palette color pattern information may represent a plurality of palette colors by combining three pixel colors of black (K), white (W), and red (R). According to another embodiment, the palette color pattern information may represent a plurality of palette colors by combining four pixel colors of black (K), white (W), yellow (Y), and red (R). The pixel color may be the basic color that the electronic label device can display.

FIG. 5 illustrates seven palette colors #1, #2, #3, #4, #5, #6, and #7, but this is only an example and information of more palette colors can be illustrated. For example, in the case of the electronic label device 2000 that supports three colors (e.g., R, W, and K), the palette color pattern data can represent 10 palette colors obtained by combining these colors, in the case of the electronic label device 2000 that supports four colors (e.g., R, W, K, and Y), the palette color pattern data can represent 22 palette colors obtained by combining these colors, and in the case of the electronic label device 2000 that supports six colors (e.g., R, W, K, Y, B, and G), the palette color pattern data can represent 50 palette colors obtained by combining these colors. When each color is adjusted to have a predetermined color coordinate value in the color coordinates, various colors can be expressed. The order in which colors are arranged may be independent of the display of a particular color.

According to one embodiment, the palette color pattern information may further include information about pixel colors (e.g., R, W, K, Y, B, and G). Therefore, the electronic label device 2000 may directly display pixel colors (basic colors) for some display areas.

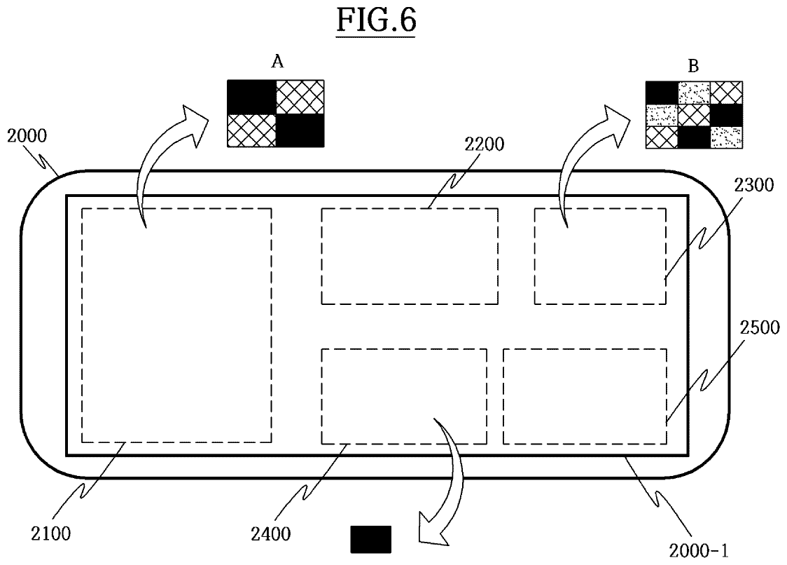

FIG. 6 illustrates an electronic label device that displays various colors according to a display template according to one embodiment. The electronic label device 2000 may have a predetermined display template. The electronic label device 2000 includes a display 2000-1. As illustrated in FIG. 6, the display 2000-1 of the electronic label device 2000 may display several areas 2100, 2200, 2300, and 2400 for displaying information such as a product image, a product name, a price, a discount rate, and a country of origin using a display template having a two-dimensional shape.

For example, display areas such as the product image display area 2100, the product name display area 2200, a price display area 2300, the discount rate display area 2400, and/or a country of origin display area 2500 may be included in the display. When displaying clothing images, for example, such as lingerie and jeans, in the product image display area 2100, a specific color (pink or sky blue) combined like pixel color group A may be displayed, and when displaying a price in the price display area 2300, a specific color combined like pixel color group B may be displayed.

Although limited pixel colors (black, white, red, yellow, blue, and green) are used in each area, various colors can be expressed by applying the palette color pattern data of the present invention. For example, when pixel color group A is applied to a specific area of the electronic label device, a specific color can be expressed with a combination of black and yellow pixels, and when pixel color group B is applied to another area, a different color can be expressed with a more complex combination of pixels.

According to one embodiment, it is not necessary to display all display areas with combined pixel colors, and some display areas, such as the discount rate display area 2400, may be displayed with a basic color (e.g., black) of three colors, four colors, or six colors.

In this way, the present invention may allow various colors to be expressed even in an electronic label device with limited pixel colors, thereby improving the visibility of product information and attracting consumer interest.

According to the proposed invention, even when the electronic label device supports only limited pixel colors of three, various colors can be expressed through color combinations of adjacent pixels, thereby providing visually rich colors.

Furthermore, the proposed invention has the effect of reducing the burden on data processing of the management server and reducing network traffic by generating color image data in the access point device.

In addition, the proposed invention has the effect of maximizing the design and utilization range through rich color reproduction beyond the simple color expression of the electronic label device and improving visual quality, especially in the product introduction and display fields where accurate color tone expression is required.

The present invention has been described above through embodiments referring to the accompanying drawings but is not limited thereto. The present invention should be interpreted to encompass various modifications that may be obviously derived from the embodiments by those skilled in the art. The scope of the patent claims is intended to encompass such modifications.

What is claimed is:

1. An access point device that interfaces between an electronic label device including a display and a management server, comprising:
a server communication circuit connected to the management server through a first network;
a wireless communication circuit connected to the electronic label device through a second network;
a memory in which a display template including program instructions and configuration information of a display are stored; and
a processor configured to execute the program instructions,
wherein the program instructions, when executed by the processor, perform:
a reception control operation of color display control data to control the server communication circuit to receive the color display control data from the management server;
a reception operation of the color display control data to receive the color display control data from the server communication circuit;
a processing operation of the color display control data to process the color display control data;
a generation operation of color image data to generate the color image data to be displayed on the display from the color display control data according to the display template stored in the memory, but generating the color image data differently according to the configuration information of the display; and
a transmission control operation of the color image data to control a wireless communication circuit to receive the color image data and wirelessly transmit the color image data to the electronic label device.

2. The access point device of claim 1, wherein the processing operation of the color display control data includes:
a determination operation of the number of colors to determine whether the number of colors that the display displays is less than the number of colors according to the received color display control data; and
a dithering processing operation for performing dithering on the color display control data when the number of colors that the display displays is less than the number of colors according to the received color display control data

3. The access point device of claim 1, wherein the color display control data includes metadata including at least one of a resolution and the number of colors.

4. The access point device of claim 1, wherein the display template is formed of metadata including at least one of a product image, a product name, a price, a discount rate, and a country of origin.

5. The access point device of claim 1, wherein the processor transmits the color image data to a wireless communication circuit in a compressed state using a DEFLATE algorithm according to a radio frequency coding (RFC) 1951 standard.

6. The access point device of claim 1, wherein the color image data includes color information in which at least two of black (B), white (W), and red (R) are combined.

7. The access point device of claim 1, wherein the color image data includes color information in which at least two of black (B), white (W), yellow (Y), and red (R) are combined.
